(19) United States
(12) Patent Application Publication
(10) Pub. No.: US 2004/0118769 A1
(43) Pub. Date: Jun. 24, 2004

(54) ICE-TRAP BRINGS LIQUID DRINKS TO ITS FULLEST POTENTIAL

(76) Inventor: Jaime A. Merino, La Mesa, CA (US)

Correspondence Address: Jaime Merino, 4681 Dauer Ave, La Mesa, CA, 91941, US

(21) Appl. No.: 10/219,583

(22) Filed: Dec. 24, 2002

(51) Int. Cl. B01D 35/02; A47G 21/18

(52) U.S. Cl. 210/459; 210/467

(57) ABSTRACT

The ICE-TRAP is an invention that makes the drinking process a much more enjoyable and profitable experience. This is because the ICE-TRAP adds quality to existing drinking products, while at the same time making them more efficient for the consumer and the producer. The effectiveness of the ice trap can be seen not only in its design but also in the simplicity of the principles the ICE-TRAP is based on. Ice floats in liquid because of its density, ice cools the liquid, liquid comes through the end of the straw. The ICE-TRAP utilizes the buoyancy of the ice to trap it at the end of the straw where the liquid flows through. The effect of this product will be seen in the fact that drinks will last for a longer period of time, people will not have to sacrifice their drink with too much ice. And the temperature of their drink will be much cooler for a longer period of time.

### DESCRIPTION

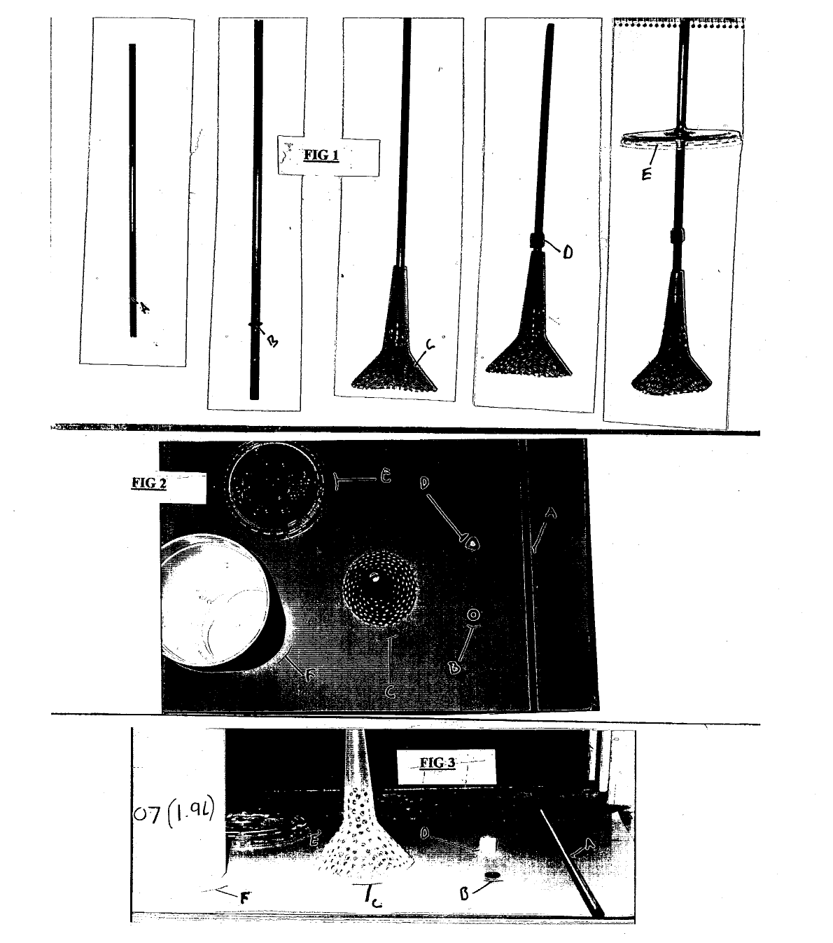

FIG. 1 shows the 5 steps necessary to put the ICE-TRAP together. Step 1: a plain straw (A), that would be at any common convenient store. Step 2: stretch the snug rubber washer (B), around the end of the straw. Then slide the snug rubber washer (B), approximately two inches from the bottom of the straw. Step 3: take the ICE-TRAP's plastic net (C), and allow the straw (A), to pass through the middle of it until the snug rubber washer (B), stops it at the other end of the straw. Step 4: place the snug rubber washer (D), through the top of the straw (A), like step three, except slide it down the straw (A), until it is about an inch above the plastic net (C). The last step in putting the ICE-TRAP together is simply puncturing the drink lid (E), through the bottom with the straw (A), then take the entire ICE-TRAP unit with the lid (E), and place it in the soft drink cup and watch it capture the ice and bring with the end of the straw to the bottom of the cup

FIG. 2 shows the top view of the straw (A), the bottom snug rubber washer (B), the plastic net (C), the top snug rubber washer (D), the drink lid (E), and soft-drink cup

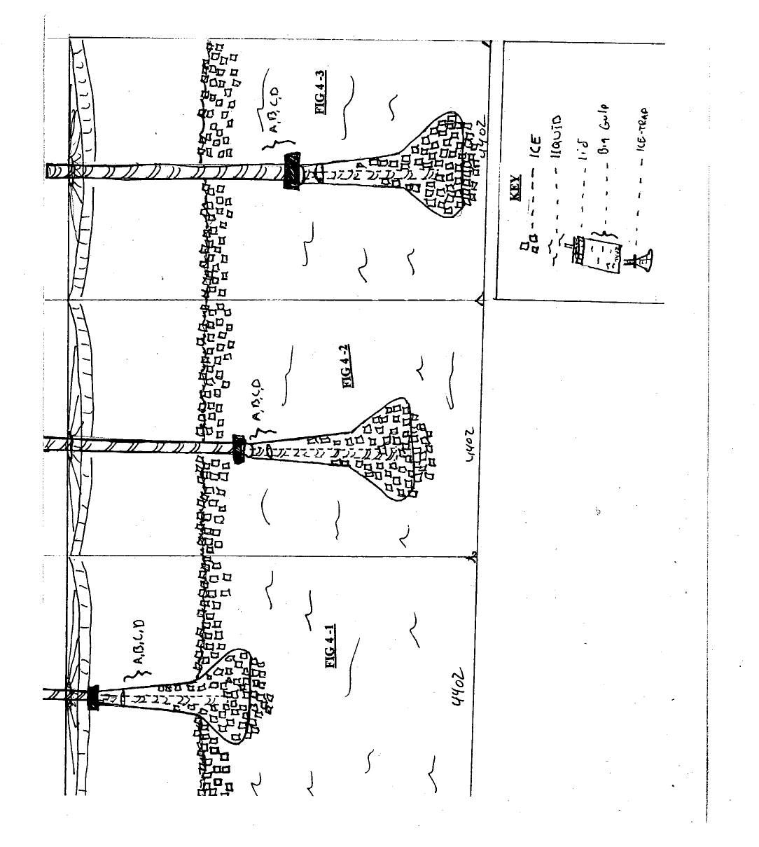

FIG. 3 shows the side view of the straw (A), the bottom snug rubber washer (B), the plastic net (C), the top snug rubber washer (D), the drink lid (E), and soft-drink cup (E).

FIGS. 4-1-4-3 shows the process in which the ICE-TRAP traps the ice. There is also a KEY to help the viewer identify the different parts of the sketches. FIG. 4-1 shows the ICE-TRAP's initial plunge into the liquid and ice, immediately trapping ice as the straw makes it decent to the bottom of the cup. FIG. 4-2 shows the ice trapped in the ICE-TRAP's plastic net while the rest of the ice floats on the top distant from the end of the straw. FIG. 4-3 shows the ICE-TRAP resting at the bottom of the drink insulated by the cold ice trapped around the straws end.

Reference Letters

An Ordinary straw

B Bottom Snug Rubber Washer

C Plastic Net

D Top Snug Rubber Washer

E Soft Drink Lid

F Soft Drink Cup

### OPERATION

In operation use the ICE-TRAP in the same manner as a normal straw. As a result of the ICE-TRAP's presence, five effects take place:

1) Less ice is necessary since the ICE-TRAP keeps the ice where it is effective, around the end of the straw.

2) Since the ice is caught at the end of the straw, liquid is cooled immediately before it enters the straws

3) Since less ice is necessary, there is not as much melted ice to flatten and destroy the drink.

4) The drink ultimately lasts longer, stays cooler, and taste better than any soft drink that's being offered presently. The summer months make the ICE-TRAP's benefits that much more apparent.

5) The ICE-TRAP gives the seller a higher quality product that is cost effective and gives them the edge over any other soft-drink business. The ICE-TRAP gives the buyer a product that is going to last longer, be less flat, and give you the coolest drink possible.

1) The first claim is the top plastic or rubber (flexible) washer, which fits tightly around the straw; this keeps the ICE-TRAP's net from sliding up.

2) The second claim is the ICE-TRAP's net which is shaped like a funnel, its opening is also bigger at the end and gets narrower as is gets to the straw opening. The net is also halo at the middle so that the straw can slide through the middle. The net can also be made at different sizes and of different material to fit the diameter of different cups.

3) The third claim is the holes in the net, which allow water to move through it freely, while being to small for the ice to flow through therefore it gets trapped.

4) The fourth claim is the bottom plastic or rubber (flexible) washer, which fits tightly around the straw, this keep the ICE-TRAP's net from sliding off the bottom

5) The fifth claim is the system, which involves using a contraption at the end of the straw in order to keep the ice at the end in order to immediately cool the liquid entering the straw.
